(19) United States
(12) Patent Application Publication
(10) Pub. No.: US 2025/0102326 A1
(43) Pub. Date: Mar. 27, 2025

(54) INDUCTIVE POSITION SENSOR DEVICE AND BRAKE SYSTEM HAVING AN INDUCTIVE POSITION SENSOR DEVICE

(71) Applicant: Continental Automotive Technologies GmbH, Hannover (DE)

(72) Inventors: Jens Habig, Kronberg (DE); Andreas Donner, Frankfurt am Main (DE); Anselm Knobloch, Frankfurt am Main (DE)

(73) Assignee: Continental Automotive Technologies GmbH, Hannover (DE)

(21) Appl. No.: 18/729,024

(22) PCT Filed: Dec. 15, 2022
(86) PCT No.: PCT/DE2022/200300

§ 371 Date: Jul. 15, 2024

(30) Foreign Application Priority Data
Jan. 14, 2022 (DE) 10 2022 200 420.5
Mar. 14, 2022 (DE) 10 2022 202 500.8

(51) Int. Cl. G01D 5/20; B60T 13/12; B60T 13/58; B60T 13/74; B60T 17/22

(52) U.S. Cl. CPC G01D 5/2053; B60T 17/22; B60T 13/12; B60T 13/588; B60T 13/74; G01D 2205/24

(57) ABSTRACT

An inductive position sensor device for detecting a positional location of a position encoder element having a position reception device, wherein the position reception device includes a printed circuit board of multilayer design and having a coil assembly, wherein the coil assembly includes at least one excitation coil and at least a first and a second reception coil, wherein the first and the second reception coil each include a number of windings which are at least partly surrounded by the excitation coil, wherein the first reception coil includes a compensation winding which is arranged at least in certain areas above and/or below a subsection of the excitation coil.

### CROSS-REFERENCE TO RELATED APPLICATIONS

This application is a national stage application, filed under 35 U.S.C. § 371, of International Patent Application No. PCT/DE2022/200300, filed on Dec. 15,2022, which claims priority to German patent applications Nos. 10 2022 200 420.5, filed on Jan. 14, 2022, and 10 2022 202 500.8, filed on Mar. 14, 2022, each of which are incorporated by reference.

### TECHNICAL FIELD

The technical field relates to an inductive position sensor device and a brake system including such an inductive position sensor device.

### BACKGROUND

Inductive position sensors are widely used in the automotive sector. Such position sensors are used, for example, to detect linear positional locations or rotational angular positions of a moving element. For example, coil systems which indicate the position of a moving position encoder element via mutual coupling (electric field to voltage) are used as position reception device. At least one excitation coil and at least two reception coils are used. Such coils are known to be printed/applied to printed circuit boards, as is known from document U.S. Pat. No. 20,204,00465 A1, for example.

The position encoder element is usually a moving component made of conductive, usually non-ferromagnetic, material. This may be, for example, a cylinder piston of a master brake cylinder of a brake actuation device or an impeller on a drive shaft of an electric motor.

Such sensors operate in accordance with the inductive principle. In this case, use is made of the fact that both conductive and ferromagnetic materials influence the properties of an electromagnetic coil. The change in the coupling between the excitation coil and the at least two reception coils caused by the metallic element leads to a change in the voltage, which is registered and evaluated by an evaluation unit.

In the case of angle sensors, a 360° wrap-around coil assembly is usually used at present. In the case of a C-shaped coil structure, a “Pos1/2<>Neg1/2 and Pos1/4<>Neg1/2<>Pos1/4” reception coil structure can significantly reduce the surface area. C-shaped coil structures (or C-shaped printed circuit boards) offer a much more cost-effective alternative to a 360° variant. However, a maximum compression of the required usable surface area by the “Pos1/2<>Neg1/2 and Pos1/4<>Neg1/2<>Pos1/4” reception coil structure results in an imbalance in the generated signals. One of the two signals from the two reception coils is loaded asymmetrically to such an extent that a large offset results. The signal mean value of the asymmetrically loaded reception coil is therefore no longer optimally adapted to a signal evaluation electronics system, such as an analog-to-digital converter, for example. The different offset voltages of the first and second output signals therefore do not make it possible to amplify both signals in such a way that optimal utilization of the available voltage ranges is ensured. The result is a loss of signal robustness.

There remains an opportunity of reducing the offset voltage of the cosine signal of a motor position sensor in order to enable a maximum amplitude gain of both reception signals (Sin & Cos). The robustness with respect to mechanical tolerance in the installed sensor printed circuit board to the sensor counterpart (for example the impeller) is therefore greater. This results in less waste in production and robustness in terms of safety-critical conditions in the event of position drift.

There also remains an opportunity to provide an inductive position sensor device which produces a small offset of the signals of the at least two reception coils that are output.

### SUMMARY

The disclosure provides an inductive position sensor device for detecting a positional location of a position encoder element having a position reception device The position reception device includes a printed circuit board of multilayer design and having a coil assembly. The coil assembly includes at least one excitation coil and at least a first and a second reception coil. The first and the second reception coil each include a number of windings which are at least partly surrounded by the excitation coil. The first reception coil includes a compensation winding which is arranged at least in certain areas above and/or below a subsection of the excitation coil.

Inserting a compensation winding into the reception coil affected by the offset induces an additional field (or voltage) from the excitation coil in the reception coil. The voltage offset is therefore shifted in the desired direction of the signal of the second reception coil.

Depending on the location of the compensation winding in relation to the excitation coil on the printed circuit board, the coupling of the excitation field is influenced by the position of the position encoder element in the compensation winding. This in turn leads to a disturbing influence on the compensation field depending on the position of the position encoder element. The proposed compensation winding also solves these adversities by virtue of the fact that the compensation winding is explicitly positioned in the area of the overlying sensor counterpart.

In order to achieve offset compensation which is independent of the position encoder element, the length (or, in the case of an angle sensor, the angle opening) of the compensation winding is selected in such a way that the full surface area of the position encoder element and a clearance of the position encoder element (for example a non-blade in the angle sensor) always outweigh the compensation winding. The influence of the position of the position encoder is therefore offset.

This has the advantage that there is a high degree of robustness with respect to mechanical position changes. In addition, there are no restrictions, and so the printed circuit board circuit design is independent. The resulting greatly reduced space requirement on the printed circuit board leads to a reduction in costs.

The assembly of the compensation winding described herein also has the advantage that the position sensor device outputs good measurement results without regular calibration.

The printed circuit board of multilayer design may include a first layer, a second layer, and at least one intermediate layer arranged between the first and the second layer, wherein the excitation coil includes a number of windings which are applied to the first and second layer, wherein the compensation winding of the first reception coil is applied to the first intermediate layer, and the compensation winding is arranged in certain areas in a vertical area between the windings of the excitation coil of the first layer and the windings of the excitation coil of the second layer.

In addition, the compensation winding is integrated between the excitation coil in the printed circuit board layers in such a way that only the part of the excitation field necessary for compensation is coupled into the compensation winding. There is therefore also virtually no additional surface area required for the compensation winding on the entire printed circuit board.

According to a one embodiment, the first reception coil is applied by way of the windings thereof to the first and the second intermediate layer. According to another embodiment, the second reception coil is applied by way of the windings thereof to the first and the second intermediate layer, wherein the second intermediate layer is arranged between the first and second layer.

The windings of the first and the second reception coil may each include a number of positive and negative windings, wherein these positive and negative windings are surrounded diametrically by the windings of the excitation coil.

The first reception coil may be a cosine reception coil. The second reception coil may be a sine reception coil.

Furthermore, the excitation coil, the first and the second reception coil each include a connection to an evaluation unit.

The inductive position sensor device may be used in a brake system of a motor vehicle. There, the position sensor device is used for determining the travel of a brake cylinder piston or for determining the rotor position of a drive shaft having an impeller of an electric motor. The brake cylinder piston or the impeller in this case represent the position encoder element of the position sensor device.

### BRIEF DESCRIPTION OF THE DRAWINGS

Further embodiments of the disclosure emerge from the following description of exemplary embodiments on the basis of the figures, in which:

FIG. 1 shows a first exemplary inductive position sensor device,

FIG. 2 shows the first exemplary inductive position sensor device in detail,

FIG. 3 shows a second exemplary inductive position sensor device,

FIG. 4 shows a coil assembly of the first exemplary inductive position sensor device from FIG. 1,

FIG. 5 shows a coil assembly of the second exemplary inductive position sensor device from FIG. 2, and

FIG. 6 shows an exemplary position reception device.

### DETAILED DESCRIPTION

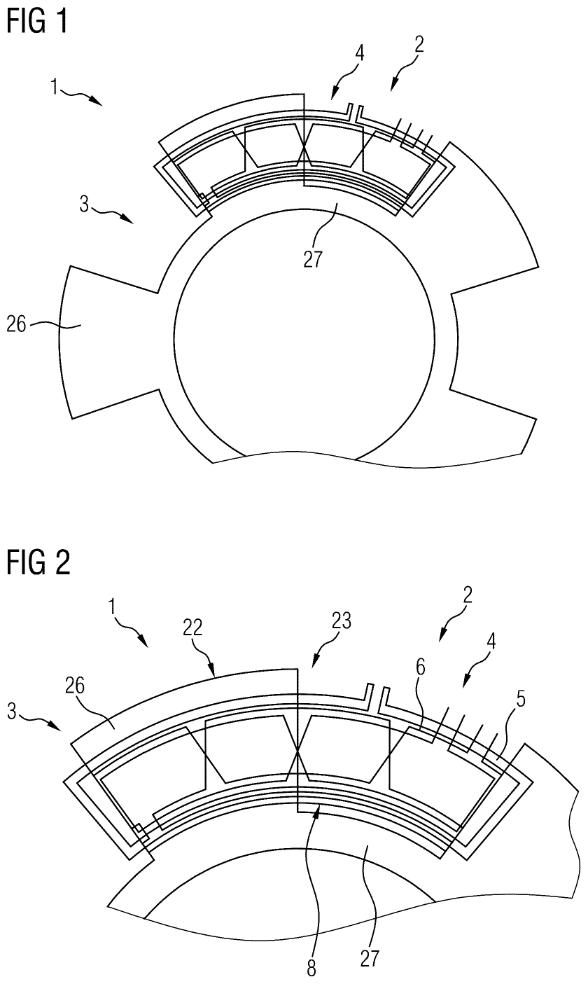

FIG. 1 shows a first exemplary inductive position sensor device 1 having a position reception device 2 and a position encoder element 3. The position reception device 2 includes a printed circuit board (not shown) having a coil assembly 4 which includes at least three coils. In the example shown, the position encoder element 3 is in the form of an impeller 26. The impeller 26 is designed to be fixed via its fastening ring 27 onto a drive shaft (not shown) of an electric motor. The position reception device 2 and the position encoder element 3 are arranged spatially with a slight distance on top of one another or next to one another. The impeller 26 is made of a metallic material. The impeller 26 is made of a non-ferromagnetic material. The impeller 26 is electrically conductive.

FIG. 2 shows this position sensor device 1 in more detail. The impeller 26 is shown as slightly transparent to illustrate the underlying coil assembly 4. The exact design of the coil assembly 4 is discussed in more detail in FIGS. 4 to 6. The coil assembly 4 includes at least one excitation coil 5 and at least one first reception coil 6. The first reception coil 6 comprises a number of windings, including a compensation winding 8. The impeller 26 comprises at least one blade 22 and at least one blade recess 23. Several blades and blade recesses which alternate in the direction of rotation can be provided on the impeller 26. The impeller 26, made for example of an aluminum material, rotates by way of its blade 22 when the drive shaft of the electric motor is driven via the printed circuit board, which is not shown, by way of its coil assembly 4. The blade 22 repeatedly slips over the coil assembly 4 and in the process influences the induced voltage in the first reception coil 6 and a second reception coil. The rotation position of the drive shaft of the electric motor is determined by changing the coupling of an excitation field from the excitation coil 5 into the first and second reception coil, which results from a blade 22 and the subsequent blade recess 23 slipping over.

The compensation winding 8 of the first reception coil 6 is arranged at least in certain areas above or below a subsection of the excitation coil 5. The compensation winding 8 in this case follows the curved shaping of the subsection of the excitation coil 5.

Furthermore, the compensation winding 8 is arranged such that the fastening ring 28 of the impeller 26 is not located above it. The compensation winding 8 is arranged in such a way that the blade 22 and the blade recess 23 are moved over it.

In the example, the position reception device 2 is C-shaped according to FIGS. 1 and 2. This means that the printed circuit board, which is not shown, and coil assembly 4 are also C-shaped. Although such a C-shape requires less installation space, it places higher demands on good signal quality.

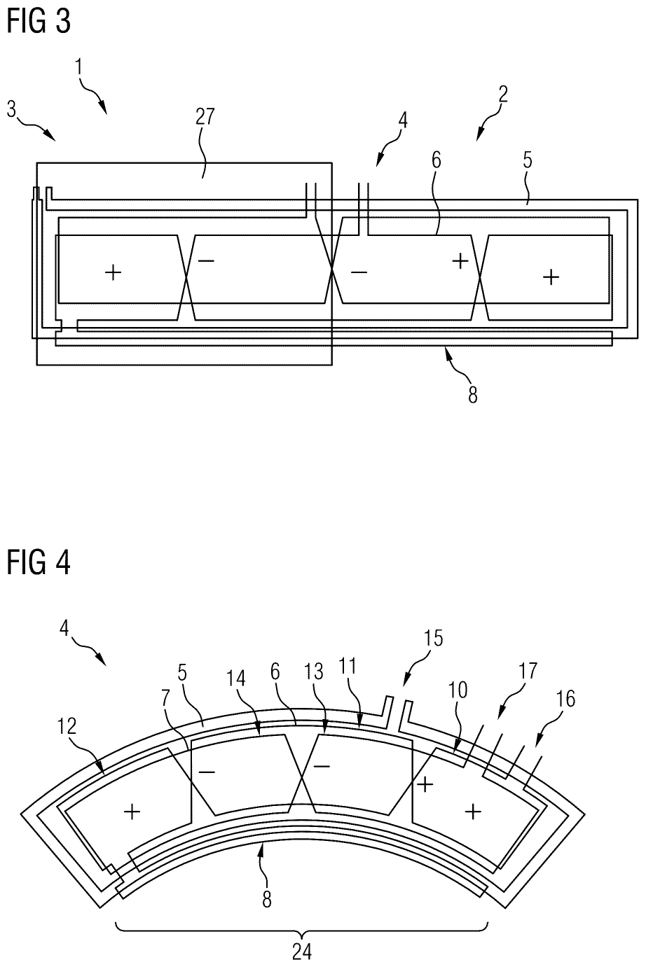

FIG. 3 shows a second exemplary inductive position sensor device 1 including a position reception device 2 and a position encoder element 3. The position reception device 2 likewise includes a printed circuit board (not shown) having a coil assembly 4 which includes at least three coils. In the example shown, the position encoder element 3 is a cylinder piston 27. The cylinder piston 27 belongs, for example, to a master brake cylinder of a brake actuation device. When the brake actuation device is actuated, the cylinder piston 27 moves parallel to the position reception device 2. As a result, the position or the travel distance of the cylinder piston 27 can be detected by means of the position reception device 2. This travel distance represents, for example, the driver's brake request. The position reception device 2 is, for example, mounted in or on the cylinder housing of the brake actuation device, within which the cylinder piston 27 moves linearly.

The coil assembly 4 also includes the excitation coil 5 and the first reception coil 6 having the compensation winding 8. The compensation winding 8 of the first reception coil 6 is arranged at least in certain areas above or below a subsection of the excitation coil 5. The compensation winding 8 in this case follows the linear shaping of the subsection of the excitation coil 5. In the example shown, the position reception device 2 is rectangular.

FIG. 4 shows the coil assembly 4 of the position reception device 2 of the first exemplary inductive position sensor device 1 from FIG. 1 in more detail.

The coil assembly 4 includes the excitation coil 5 having a connection 15, the first reception coil 6 having a connection 16 and a second reception coil 7 having a connection 17. The first reception coil 6 includes a number of windings. Provided in the connection 16 is a first positive winding 10, which transitions into a negative winding 11, which in turn transitions into a second positive winding 12. The compensation winding 8 branches off from the second positive winding 12. The compensation winding 8 extends over a subsection 24 of the excitation coil 5. In this case, the compensation winding 8 is located above or below the subsection 24 of the excitation coil 5. The reception coil 6 is a so-called cosine reception coil.

The second reception coil 7 includes, at the connection 17, a positive winding 13, which transitions into a negative winding 14.

The windings 10, 11 and 12 of the first reception coil 6, as well as the windings 13 and 14 of the second reception coil 6, are surrounded diametrically by the excitation coil 5. The excitation field of the excitation coil 5 thus induces a voltage in the windings 10 to 14 of the first and second reception coils 6 and 7.

In this case, the compensation winding 8 of the first reception coil 6 is exposed to the excitation field of the excitation coil 5 in such a way that the portion of the excitation field passing through the compensation winding 8 induces a defined portion of additional voltage in the compensation winding 8. This voltage corresponds to the portion necessary to compensate for the shifted offset.

FIG. 5 shows a similar structure of the coil assembly 4, which shows the coil assembly 4 of the second exemplary inductive position sensor device 1 from FIG. 3. In this case, the coil assembly 4 is rectangular. The first and second reception coils 6 and 7 comprise the same number and type of windings 8, 10 to 14, as explained in the above example.

In this case, too, the compensation winding 8 extends from the first reception coil 6 over a subsection of the excitation coil 5.

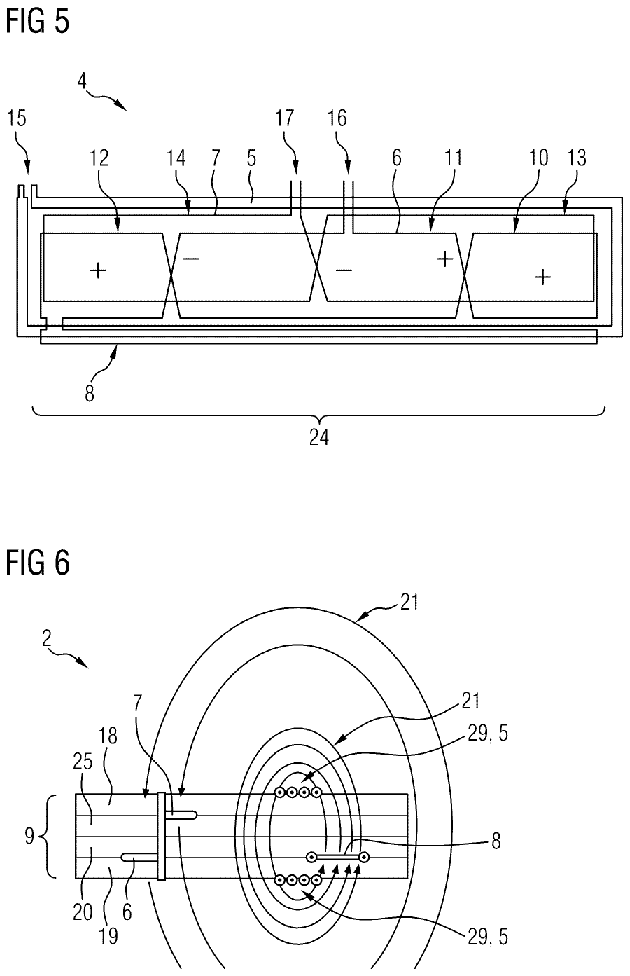

FIG. 6 illustrates in section the position reception device 2 with its multilayer printed circuit board 9. The printed circuit board 9 comprises a first (top) layer 18 and a second (bottom) layer 19. A first intermediate layer 20 and a second intermediate layer 25 is provided in between. The first intermediate layer 20 faces the second layer 19. The second intermediate layer 25 faces the first layer 18.

As an example, the excitation coil 5 comprises a number of windings 29. These windings 29 are applied to the first layer 18 and to the second layer 19 at the same time. At several connecting points, the excitation coil passes from the first layer 18 to the second layer 19 and back again. The energization of the excitation coil 5 with an alternating current generates an excitation field 21. The excitation field 21 acts on the windings of the first and second reception coils 6 and 7. The excitation field 21 acts, in particular, on the compensation winding 8 from the first reception coil 6.

The positive and negative windings of the first and second reception coils 6 and 7 are located on the side of the windings 29 of the excitation coil 5. The positive and negative windings are surrounded by the excitation coil 5 and are slightly spaced apart from their windings 29. As a result, a weak excitation field 21 is applied to the positive and negative windings. The positive and negative windings of the first and second reception coil 6 and 7 are located in the intermediate layers 20 and 25 of the printed circuit board 9. It is possible that the positive and negative windings of the respective reception coil 6 and 7 pass from the first intermediate layer 20 to the second intermediate layer 25 and back again at corresponding connecting points. As a result, the positive and negative windings of the reception coil 6 and 7 extend vertically through the printed circuit board 9. The positive and negative windings of the reception coil 6 and 7 run in the horizontal direction as shown in FIGS. 3 to 5.

As an example, the compensation winding 8 of the first excitation coil 5 is applied to the first intermediate layer 20. As an example, a subregion of the compensation winding 8 is located in a vertical region between the excitation coil 5, which is applied to the first layer 18 and the second layer 19 of the printed circuit board 9. This means that the compensation winding 8 is within a strong effective range of the excitation field 21.

The excitation field 21 as a result induces a voltage not only in the positive and negative windings of the first reception coil 6, but also in the compensation winding 8. Thus, the signal offset of the first reception coil 6 is changed such that the signal from the first reception coil 6 approximates the signal from the second reception coil 7.

### LIST OF REFERENCE SIGNS

1 Position sensor device
2 Position reception device
3 Position encoder element
4 Coil assembly
5 Excitation coil
6 First reception coil
7 Second reception coil
8 Compensation winding
9 Printed circuit board
10 First positive winding of the first reception coil
11 Negative winding of the first reception coil
12 Second positive winding of the first reception coil
13 Positive winding of the second reception coil
14 Negative winding of the second reception coil
15 Connection of the excitation coil
16 Connection of the first reception coil
17 Connection of the second reception coil
18 First layer
19 Second layer
20 First intermediate layer
21 Excitation field
22 Blade
23 Blade recess
24 Subsection
25 Second intermediate layer
26 Impeller
27 Cylinder piston
28 Fastening ring
29 Windings

1. An inductive position sensor device for detecting a positional location of a position encoder element having a position reception device, wherein the position reception device comprises:
a printed circuit board of multilayer design and having a coil assembly:
wherein the coil assembly comprises at least one excitation coil and at least a first and a second reception coil;
wherein the first and the second reception coil each comprise a number of windings which are at least partly surrounded by the excitation coil; and
wherein the first reception coil comprises a compensation winding which is arranged at least in certain areas above and/or below a subsection of the excitation coil.

2. The inductive position sensor device as claimed in claim 1, wherein the printed circuit board of multilayer design comprises a first layer, a second layer and at least one intermediate layer arranged between the first and the second layer, wherein the excitation coil comprises a number of windings which are applied to the first and second layer, wherein the compensation winding of the first reception coil is applied to the first intermediate layer, and the compensation winding is arranged in certain areas in a vertical area between the windings of the excitation coil of the first layer and the windings of the excitation coil of the second layer.

3. The inductive position sensor device as claimed in claim 2, wherein the first reception coil is applied by way of the windings thereof to the first and the second intermediate layer.

4. The inductive position sensor device as claimed in claim 3, wherein the second reception coil is applied by way of the windings thereof to the first and a second intermediate layer, wherein the second intermediate layer is arranged between the first and second layer.

5. The inductive position sensor device as claimed in claim 4, wherein the windings of the first and the second reception coil each comprise a number of positive and negative windings, wherein these positive and negative windings are surrounded diametrically by the windings of the excitation coil.

6. The inductive position sensor device as claimed in claim 5, wherein the first reception coil is a cosine reception coil.

7. The inductive position sensor device as claimed in claim 6, wherein the second reception coil is a sine reception coil.

8. The inductive position sensor device as claimed in claim 7, wherein the excitation coil the first reception coil, and the second reception coil each comprise a connection to an evaluation unit.

9. A brake system for a motor vehicle, comprising:
a brake actuation device having a movable brake cylinder piston and/or an electric motor having a drive shaft and an impeller;
wherein a position encoder element of a position sensor device is represented by the brake cylinder piston or the impeller and includes an inductive position sensor device comprising:
a printed circuit board of multilaver design and having a coil assembly.
wherein the coil assembly includes at least one exciation coll and at least a first reception coil and a second reception coil.
wherein the first reception coil and the second reception coll each include a number of windings which are at least partly surrounded by the excitation coil and
wherein the first reception coil includes a compensation winding which is arranged at least in certain areas above and/or below a subsection of the excitation coil.
